(19) United States
(12) Patent Application Publication
(10) Pub. No.: US 2026/0027469 A1
(43) Pub. Date: Jan. 29, 2026

(54) DYNAMICALLY CALIBRATING SETTINGS FOR CONTENT SYSTEMS AND APPLICATIONS

(71) Applicant: NVIDIA Corporation, Santa Clara, CA (US)

(72) Inventors: Pankaj Kadtan, Pune (IN); Radhika Ranjan Soni, Pune (IN); Santosh Katvate, Pune (IN); Gaurav Singh, Pune (IN)

(21) Appl. No.: 18/787,704

(22) Filed: Jul. 29, 2024

(51) Int. Cl. A63F 13/60; A63F 13/22

(52) U.S. Cl. CPC A63F 13/60; A63F 13/22; A63F 2300/64

(57) ABSTRACT

In various examples, dynamically calibrating settings for content streaming systems and applications is described herein. Systems and methods are disclosed that monitor information associated with a state of a client device and/or a performance of an application (e.g., an interactive application, etc.) during a session of the application, and then update settings associated with the client device and/or the application during the session in order to optimize a performance of the application. For instance, this information may be used to determine when to update the settings, such as when a GPU utilization satisfies a threshold utilization, a frame drop rate satisfies a threshold rate, and/or the like. In some examples, the settings may then be updated using one or more techniques (e.g., using a decision tree), such as by terminating other applications, updating settings of one or more processors, and/or performing any other procedure.

### BACKGROUND

For some gaming application, the success of a player may be based on the player's reaction time, such as the time it takes for the player to observe what events are occurring with regard to the gaming application, process the events to determine how to respond, and then react with the determined response. As such, it may be important to reduce and/or eliminate lag associated with providing the gaming application to the player. In order to reduce and/or eliminate lag, conventional systems may analyze a client device before a session associated with a gaming application in order to determine information associated with resources of the client device, such as information associated with a central processing unit, a graphics processing unit, and/or a display. The conventional systems may then use this information to determine settings for the gaming application. For instance, the conventional systems may use this information to determine a resolution, a frame rate, a brightness, and/or other gaming settings that may help minimize the lag while also maintaining a high level of game performance.

However, in some circumstances, during a session associated with a gaming application, other events with regards to a client device and/or an application may occur that may reduce the performance of the client device. For example, during the session, the client device may launch one or more other applications, such as a background application and/or an application that is related to the gaming application, where the other application(s) may require usage of at least a portion of the resources (e.g., the GPU) of the client device. For another example, during the session, the client device may switch from using an external power source to using an internal power source, which may reduce and/or limit performance of at least a portion of the resources (e.g., the GPU) of the client device. Based on an occurrence to either of these events (and/or other events), the performance of the gaming application on the client device may reduce, such as by increasing a frame drop rate and/or lag associated with the gaming application.

### SUMMARY

Embodiments of the present disclosure relate to dynamically calibrating settings for content streaming systems and applications. Systems and methods are disclosed that monitor information associated with a state of a client device and/or a performance of an application (e.g., an interactive application, etc.) during a session of the application, and then update settings associated with the client device and/or the application during the session in order to optimize the performance of the application. For instance, state information (e.g., resource utilization, performance clocks, other executed applications, power source states, etc.) associated with the client device and/or performance information (e.g., frame rates, frame drop rates, latency, etc.) associated with the application may be monitored. This information may then be used to determine when to update the settings, such as when a GPU utilization satisfies a threshold utilization and/or the frame drop rate satisfies a threshold rate. In some examples, the settings may be updated using one or more techniques (e.g., using a decision tree), such as by terminating the other applications, updating settings of one or more processors, updating visual settings associated with the application, and/or performing any other procedure. This way, after updating the settings during the session, the performance of the application may be optimized, such as by increasing the frame rate and/or reducing the lag.

In contrast to conventional systems, such as those described above, the systems of the present disclosure may monitor the state information and/or the performance information during the session associated with the application in order to dynamically update the settings during the session. As such, the systems of the present disclosure may continue to optimize the performance of the application during the session, in contrast to the conventional systems that merely update the settings before the session such that the performance of the application may degrade when the state of the client device changes during the session. Additionally, in contrast to the conventional systems, the systems of the present disclosure may use additional state information to determine when to update the settings, such as information indicating other applications being executed by the client device and/or power source information associated with the client device. This way, and as described in more detail herein, the systems of the present disclosure may use this additional state information to better determine how to update the settings in order to improve the performance.

Furthermore, in some embodiments, and further in contrast to the conventional systems, the systems of the present disclosure may use various procedures to determine how to update the settings, such as procedures that are associated with a decision tree. As described in more detail herein, these procedures may be determined and/or updated using data representing how the client device and/or one or more additional client devices previously updated settings in order to optimize the performance of the application and/or additional applications. For instance, this data may be stored and/or updated by one or more remote systems, where the remote system(s) may then provide the data to the client device such that the client device is able to utilize the data when determining procedures for optimizing the performance of the application.

### BRIEF DESCRIPTION OF THE DRAWINGS

The present systems and methods for dynamically calibrating settings for content streaming systems and applications are described in detail below with reference to the attached drawing figures, wherein:

FIG. 1 illustrates an example of a process of dynamically updating settings associated with an application to optimize a performance of the application, in accordance with some embodiments of the present disclosure;

FIGS. 2A-2B illustrate examples of updating settings associated with an application during a session associated with the application, in accordance with some embodiments of the present disclosure;

FIG. 2C illustrates an example of information that may be included as part of a decision tree, in accordance with some embodiments of the present disclosure;

FIG. 3 illustrates an example of an architecture for dynamically updating settings associated with an application to optimize performance of the application, in accordance with some embodiments of the present disclosure;

FIG. 4 illustrates an example of updating settings associated with an application over a period of time for which a client device is providing a session associated with the application, in accordance with some embodiments of the present disclosure;

FIG. 5 illustrates an example of optimizing between different applications over a period of time, in accordance with some embodiments of the present disclosure;

FIG. 6 illustrates a flow diagram showing a method for updating settings associated with an application to optimize a performance of the application, in accordance with some embodiments of the present disclosure;

FIG. 7 illustrates a flow diagram showing a method for updating applications executing on a client device in order to optimize a performance of an application, in accordance with some embodiments of the present disclosure;

FIG. 8 illustrates a flow diagram showing a method for using a decision tree to optimize a performance of an application, in accordance with some embodiments of the present disclosure;

FIG. 9 is a block diagram of an example content streaming system suitable for use in implementing some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Systems and methods disclosed herein are related to dynamically calibrating settings for content streaming systems and applications. For instance, a system(s) may initiate a session associated with an application on a client device. As described herein, an application may include, but is not limited to, a gaming application, a communications application (e.g., a video conferencing application, etc.), an educational application, a collaborative content creation application, and/or any other type of interactive application, and/or a multimedia application (e.g., a video streaming application, a music streaming application, a voice streaming application, a multimedia streaming application that includes both audio and video, etc.) and/or any other type of application. In some examples, the system(s) may be part of and/or include the client device. Additionally, or alternatively, in other examples, the system(s) may be remote from the client device and communicate with the client device via one or more networks (e.g., one or more wireless networks).

In some examples, the system(s) may then update states associated with the application during the session on the client device. For instance, and as described in more detail herein, during a session associated with an interactive application (e.g., a gaming application), the system(s) may receive input data representing one or more inputs received from a user via one or more input devices, such as a controller, a joystick, a keyboard, a button, a microphone (e.g., voice commands), and/or the like. The system(s) may then use the input data to update a state of the interactive application, such as by moving one or more objects (e.g., one or more characters) located within an environment (e.g., a gaming environment). Additionally, the system(s) may cause the client device to provide content associated with the updated state to a user, such as by displaying one or more frames depicting the current state and/or outputting sound associated with the current state. The system(s) may then continue to perform these processes during the session associated with the interactive application.

As described herein, in order to improve the performance of the application, such as by increasing a frame rate, reducing a frame drop rate, reducing a latency, reducing a lag, and/or improving any other performance metric associated with the application, the system(s) may dynamically update one or more settings associated with the client device and/or the application. For instance, in some examples, the system(s) may cause the client device to provide an option for optimizing the performance of the application. As described herein, the option may include a visual interface element control, such as a control that is displayed by the client device and selectable by the user, an audible control, such as audio requesting whether the user would like to activate the option, and/or any other type of control. Based at least on the user selecting the option, the system(s) may then perform one or more of the processes described herein to optimize the performance of the application. However, in other examples, the system(s) may automatically activate the process(es) to optimize the performance of the application and/or may automatically activate the process(es) unless the user opts out from activating the optimization.

The system(s) may then receive, retrieve, determine, and/or obtain data representing state information associated with the client device, such as before the session associated with the application and/or during (e.g., continuously, etc.) the session associated with the application. As described herein, the state information may include, but is not limited to, hardware utilization information (e.g., one or more computer processing units (CPU(s)) utilization, one or more graphics processing units (GPU(s)) utilization, one or more physics processing units (PPU(s)) utilization, memory utilization, etc.), clock information (e.g., CPU(s) clock speed, GPU(s) clock speed, PPU(s) clock speed, etc.), power source information (e.g., whether the client device is using an external power source or an internal power source, a health of the internal power source, etc.), application information (e.g., one or more related application being executed, one or more non-related applications being executed, etc.), state machine information (e.g., an application environment, an artificial intelligence (AI) state, a character state, etc.), methods and/or parameters issued to peripheral component interconnect express (PCI-E), and/or any other state information associated with the client device.

Additionally, in some examples, the system(s) may receive, retrieve, determine, and/or obtain data representing performance information associated with the application. As described herein, the performance information may include, but is not limited to, a frame rate, a frame drop rate, a latency, a frame resolution, and/or any other type of performance information associated with the application. The system(s) may then use the state information, the performance information, and/or any other information obtained for the client device and/or the application to determine whether to update one or more settings associated with the client device and/or the application. As described herein, in some examples, the settings may include, but are not limited to, one or more parameters associated with the GPU(s), one or more parameters associated with the CPU(s), one or more parameters associated with the PPU(s), one or more parameters associated with the application behavior and/or script, one or more parameters associated with an operating system, one or more parameters associated with a device driver, and/or any other settings.

For instance, the system(s) may use the state information to determine whether the GPU(s) utilization (and/or, in some examples, other hardware, such as the CPU(s) utilization, the PPU(s) utilization, the memory utilization, etc.) satisfies (e.g., is equal to or greater than) a threshold utilization. As described herein, a threshold utilization may include, but is not limited to, 80%, 85%, 90%, 95%, 99%, and/or any other percentage. Additionally, the system(s) may use the performance information to determine whether the frame drop rate satisfies (e.g., is equal to or greater than than) a threshold rate. As described herein, a threshold rate may include, but is not limited to, 30 frames per second (FPS), 60 FPS, 120 FPS, 240 FPS, and/or any other frame rate. In some examples, the user may set the threshold utilization and/or the threshold rate. Additionally, or alternatively, in some examples, the system(s) may set the threshold utilization and/or the threshold rate. For example, the system(s) may set the threshold utilization and/or the threshold rate based at least on the application, a type of the application (e.g., a gaming application, a communications application, etc.), and/or any other factors.

The system(s) may then use the determinations associated with the thresholding to further determine whether to update one or more of the settings associated with the client device and/or the application, such as during the session. For instance, in some examples, the system(s) may determine not to update the settings associated with the client device and/or the application based at least on the GPU(s) utilization not satisfying (e.g., being less than) the threshold utilization and/or the frame drop rate not satisfying (e.g., being less than) the threshold rate. In such examples, the system(s) may make this determination because the performance of the application is optimal, such that there is no and/or minimal lag with the client device providing the application. In some examples, the system(s) may determine to update one or more of the settings associated with the client device and/or the application based at least on the GPU(s) utilization satisfying the threshold utilization and the frame drop rate satisfying the threshold rate. In such examples, the system(s) may make this determination because the performance of the application is less than optimal, such that there is a greater than desired lag. While these are just a few example techniques for how the system(s) may determine whether to update the settings of the client device and/or the application using the thresholding, in other examples, the system(s) may use additional and/or alternative techniques.

As described herein, in some examples, the system(s) may use one or more procedures to update the setting(s) associated with the client device and/or the application. For a first example, the system(s) may update the setting(s) by terminating one or more other applications executing on the client device, such as automatically or based on a user's feedback that selects the other application(s). For a second example, the system(s) may update the setting(s) by terminating and/or updating one or more parameters (e.g., methods) associated with the PPU(s). For a third example, the system(s) may update the setting(s) based at least on terminating and/or updating one or more parameters associated with the GPU(s) (e.g., one or more parameters of a processing pipeline of the GPU(s)). Still, for a fourth example, the system(s) may update the setting(s) by updating (e.g., decreasing, increasing, etc.) one or more clocks associated with the GPU(s), the CPU(s), and/or the PPU(s), such as based on battery information. While these are just a few example procedures for how the system(s) may update the setting(s) of the client device and/or the application, in other examples, the system(s) may use additional and/or alternative procedures.

In some examples, the system(s) may use one or more techniques to select a procedure for updating the setting(s), such as a decision tree. For instance, the decision tree may indicate the various procedures that may be used for updating the setting(s). In some examples, the decision tree may further include additional information, such as various state information and/or performance information associated with the procedures. For example, the decision tree may include information indicating to use a first procedure for a first range of state information (e.g., GPU(s) utilization, etc.) and/or a first range of performance information (e.g., FPS, frame drop rate, etc.), use a second procedure for a second range of state information and/or a second range of performance information, use a third procedure for a third range of state information and/or a third range of performance information, and/or so forth. This way, the system(s) may select the procedure and/or group of procedures that will likely give the best performance based on the actual state of the client device and/or the application.

In some examples, the system(s) may generate and/or update the decision tree using previous update information associated with previous updates to the settings. As described herein, the update information may include, but is not limited to, one or more identifiers of one or more applications for which the settings were updated, state information associated with the previous updates, performance information associated with the previous updates, performance information received after the updates occurred (e.g., impacts on the GPU(s) utilization, impacts on the frame rate, impacts on the frame drop rate, etc.), and/or any other information associated with the previous updates to the settings. In other words, as the system(s) updates settings associated with one or more applications executing on the client device, the system(s) may further update the decision tree to indicate which updates best optimized the application(s) (e.g., provided the best performance with respect to the performances of the application(s)).

Additionally, or alternatively, in some examples, one or more additional systems, which may be remote from the client device, may generate and/or update one or more decision trees. For example, the additional system(s) may receive data representing the update information from one or more client devices when the client device(s) performs one or more of the processes described herein to update settings. The additional system(s) may then use the received update information to continue updating one or more decision trees associated with one or more client devices and/or one or more applications. Additionally, the additional system(s) may provide the decision tree(s) to the client device(s), such as based on request, such that the client device(s) is able to use the decision tree(s) when updating the settings. In some examples, by performing such processes, the decision tree(s) may include the most updated information for optimizing settings associated with various applications and/or client devices such that use of the decision tree(s) may provide the best optimization with regard to the application.

In some examples, the system(s) may then continue to perform one or more of these processes, such as during the session associated with the application. This way, the system(s) may continue to ensure that the performance of the application is optimized on the client device. For example, if after updating the setting(s), the system(s) determines that the GPU(s) utilization has decreased (e.g., below the threshold utilization and/or an additional threshold utilization) and/or the frame rate has increased (e.g., to be equal to or greater than a threshold rate), then the system(s) may update the setting(s) back to the original settings for the client device and/or the application. However, if after updating the setting(s), the system(s) determines that the GPU utilization has further increased and/or the frame drop rate has further increased, then the system(s) may further update one or more additional settings using one or more of the procedures described herein to try and decrease the GPU(s) utilization and/or decrease the frame drop rate.

While the examples herein described the system(s) as executing on the client device that is providing the application, in other examples, the system(s) may be remote from the client device. For example, the system(s) may communicate with the client device to receive data representing the information, such as the state information and/or the performance information. The system(s) may then perform one or more of the processes described herein to determine whether to update the setting(s) of the client device and/or determine one or more procedures for updating the setting(s). Additionally, the system(s) may send data to the client device that causes the client device to update the setting(s) using the determined procedure(s).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

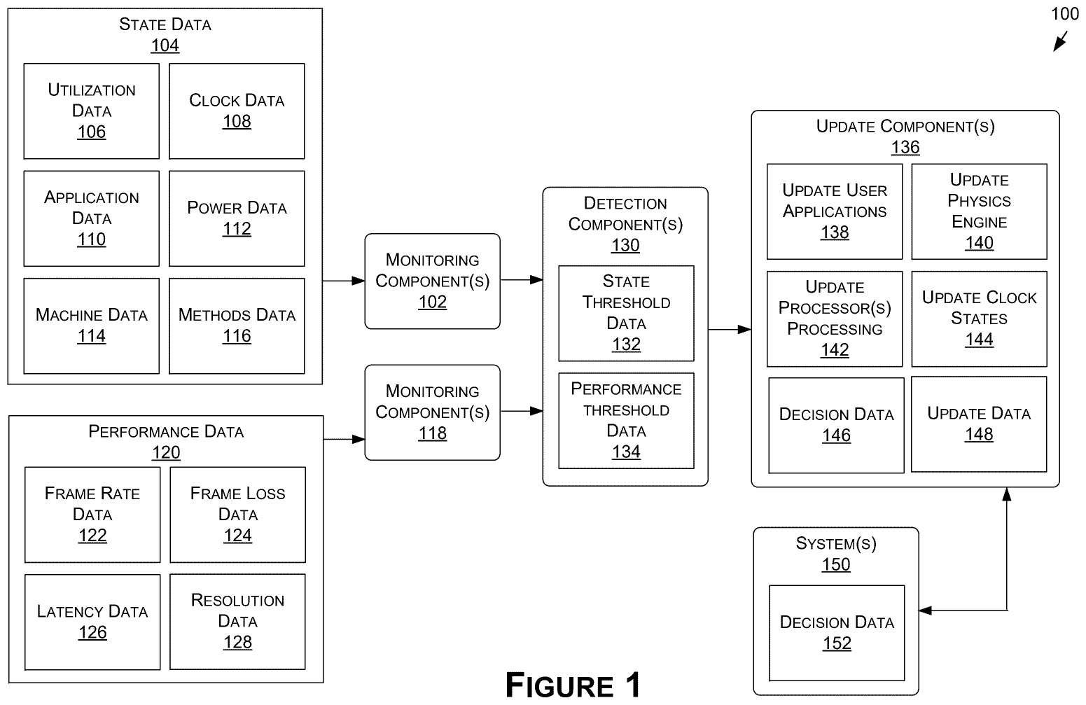

With reference to FIG. 1, FIG. 1 illustrates an example of a process 100 of dynamically updating settings associated with an application to optimize a performance of the application, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As described herein, in some examples, at least a portion of the process 100 may be performed using a client device (e.g., a client device 904) that is executing an application. For instance, the client device may launch a session associated with the application, where the client device then performs at least a portion of the process 100 before and/or during the session of the application. As described herein, an application may include, but is not limited to, a gaming application, a communications application (e.g., a video conferencing application, etc.), an educational application, a collaborative content creation application, and/or any other type of interactive application, and/or a multimedia application (e.g., a video streaming application, a music streaming application, a voice streaming application, a multimedia streaming application that includes both audio and video, etc.) or any other type of application. However, it is noted that, in some examples, at least a portion of the process 100 may additionally, or alternatively, be performed using one or more other computing devices, such as one or more application servers (e.g., an application server 902).

As shown, the process 100 may include one or more state-monitoring components 102 receiving state data 104 associated with the client device. As shown, the state data 104 may include, but is not limited to, utilization data 106, clock data 108, application data 110, power data 112, machine data 114, and/or methods data 116. As described herein, the utilization data 106 may represent information associated with one or more amounts of utilization for one or more components of the client device. For example, the utilization data 106 may represent at least an amount of utilization associated with one or more GPUs, an amount of utilization associated with one or more CPUs, an amount of utilization associated with one or more PPUs, an amount of utilization associated with one or more memories, and/or any other utilization information. Additionally, the clock data 108 may represent information associated with one or more processing clocks for one or more components of the client device. For example, the clock data 108 may represent a clock speed associated with the GPU(s), a clock speed associated with the CPU(s), a clock speed associated with the PPU(s), and/or any other clock information.

The application data 110 may represent information for one or more additional applications that are launched on and/or being executed by the client device. As described herein, in some examples, an additional application may be related to the application, such as an additional application used to communicate with other players of the application, an additional application used to stream the application to other users, an additional application used to capture moments (e.g., images, videos, etc.) from the application, and/or the like. Additionally, or alternatively, in some examples, an additional application may not be related to the application, such as a web browser application, a separate communications application, a multimedia application, and/or so forth that the user is using in addition to the application. In some examples, and as also described herein, an additional application may be launched before the session associated with the application and/or during the session associated with the application.

The power data 112 may represent information associated with one or more power sources corresponding to the application. For instance, in some examples, the power data 112 may indicate whether the client device is receiving power from one or more external power sources or from one or more internal power sources (e.g., direct current mode), such as one or more batteries. Additionally, in some examples, such as when the client device is receiving power from the internal power source(s), the power data 112 may represent additional information associated with the internal power source(s), such as an amount of remaining power associated with the internal power source(s) and/or an estimated time remaining for which the internal power source(s) will still provide power.

The machine data 114 may represent information for a finite-state machine corresponding to the application. For example, the machine data 114 may represent information indicating a state of an environment associated with the application (e.g., a gaming environment), an AI state associated with the application, a character state associated with the application, an items state associated with the application, and/or any other machine state associated with the application. Additionally, the methods data 116 may represent one or more methods and/or parameters associated with (e.g., issued to) a PCI-E associated with the client device. While these are just a few examples of information that may be represented by the state data 104, in other examples, the state data 104 may represent any other information associated with the client device.

As described herein, in some examples, the state-monitoring component(s) 102 may continuously receive updated state data 104 associated with the client device. However, in other examples, the state-monitoring component(s) 102 may receive updated state data 104 based on the occurrence of one or more events. For example, an event may include, but is not limited to, a period of time elapsing (e.g., every 1 millisecond, 10 milliseconds, 100 milliseconds, 1 second, etc.), receiving a user input indicating a request to update settings associated with the client device, determining that a performance associated with the application is degrading (e.g., a frame drop rate associated with the application satisfies a threshold rate, which is described in more detail herein), and/or any other type of event.

As further illustrated by the example of FIG. 1, the process 100 may include one or more performance-monitoring components 118 receiving performance data 120 associated with the application. While the example of FIG. 1 illustrates the performance-monitoring component(s) 118 as being separate from the state-monitoring component(s) 102, in other examples, the performance-monitoring component(s) 118 may include and/or be combined with the state-monitoring component(s) 102. Additionally, as shown, the performance data 120 may include at least frame rate data 122, frame drop data 124, latency data 126, and/or resolution data 128.

As described herein, the frame rate data 122 may represent information indicating a frame rate associated with the application, such as a current rate that the GPU(s) is able to generate frames associated with the application. In some examples, a frame rate (and/or additional a frame drop rate) may be represented using a frequency, such as 30 FPS, 60 FPS, 120 FPS, 240 FPS, and/or the like, using hertz, such as 30 Hz, 60 Hz, 120 Hz, 240 Hz, and/or the like, and/or using any other type of measurement. Additionally, the frame drop rate 124 may represent information indicating an amount the frame rate dropped over a period of time, a number of frames dropped over a period of time, and/or any other measurement associated with dropping frames. As described herein, a period of time may include, but is not limited to, 1 millisecond, 10 milliseconds, 100 milliseconds, 1 second, and/or any other period of time.

Furthermore, the latency data 126 may represent information indicating a latency associated with the application. For instance, the latency data 126 may indicate an amount of time between when the user provides an input associated with the application and the client device outputs content associated with the input. For example, if the application includes a gaming application, then the latency data 126 may represent an amount of time between when the user provides an input to move a character and client device outputs content indicating the movement of the character. Moreover, the resolution data 128 may represent information indicating a resolution associated with the frames, such as 720p, 1080p, 1440p, 2160p, and/or any other resolution. While these are just a few examples of information that may be represented by the performance data 120, in other examples, the performance data 120 may represent any other information associated with the client device.

As described herein, in some examples, the performance-monitoring component(s) 118 may continuously receive updated performance data 120 associated with the application. However, in other examples, and similar to the state-monitoring component(s) 102, the performance-monitoring component(s) 118 may receive updated performance data 120 based on the occurrence of one or more events, which are described herein.

The process 100 may then include one or more detection components 130 processing at least a portion of the information determined using the state-monitoring component(s) 102 and/or at least a portion of the information determined using the performance-monitoring component(s) 118 in order to determine whether one or more thresholds have been satisfied. For instance, in some examples, the detection component(s) 130 may use at least a portion of the information determined using the state-monitoring component(s) 102 to determine whether one or more amounts of utilization associated with one or more hardware components satisfy (e.g., are equal to or greater than) one or more threshold utilizations, where the threshold utilization(s) may be represented by state threshold data 132. For example, the detection component(s) 130 may determine whether the GPU(s) utilization satisfies (e.g., is equal to or greater than) a threshold utilization or does not satisfy (e.g., is less than) the threshold utilization. As described herein, a threshold utilization may include, but is not limited to, 80%, 85%, 90%, 95%, 99%, and/or any other percentage.

Additionally, in some examples, the detection component(s) 130 may use at least a portion of the information determined using the performance-monitoring component(s) 118 to determine whether one or more performance metrics associated with the application satisfy one or more threshold performances, where the threshold performance(s) may be represented by performance threshold data 134. For a first example, the detection component(s) 130 may determine whether the frame drop rate satisfies (e.g., is equal to or greater than) a threshold rate or does not satisfy (e.g., is less than) the threshold rate. As described herein, a threshold rate may include, but is not limited to, 30 FPS, 60 FPS, 120 FPS, 240 FPS and/or any other rate. For a second example, the detection component(s) 130 may determine whether a frame rate satisfies (e.g., is equal to or greater than) a threshold rate or does not satisfy (e.g., is less than) the threshold rate. Still, for a third example, the detection component(s) 130 may determine whether a period of time associated with a latency satisfies (e.g., is equal to or greater than) a threshold period of time or does not satisfy (e.g., is less than) the threshold period of time. As described herein, a threshold period of time may include, but is not limited to, 1 millisecond, 10 milliseconds, 100 milliseconds, 1 second, and/or any other time period.

While these are just a few examples of different types of threshold processing that may be performed using the detection component(s) 130, in other examples, the detection component(s) 130 may perform threshold processing with respect to any other state information associated with the client device and/or the application.

In some examples, the process 100 may then include the detection component(s) 130 determining when to update one or more settings associated with the client device based at least on performing the threshold processing. For a first example, the detection component(s) 130 may determine to update the setting(s) associated with the client device and/or the application based at least on the GPU(s) utilization satisfying the threshold utilization and the frame drop rate satisfying the threshold rate. For a second example, the detection component(s) 130 may determine to update the setting(s) associated with the client device and/or the application based at least on the GPU(s) utilization satisfying the threshold utilization and the frame rate not satisfying the threshold rate. Still, for a threshold example, the detection component(s) 130 may determine to update the setting(s) associated with the client device and/or the application based at least on the GPU(s) utilization satisfying the threshold utilization and the latency satisfying the threshold period of time. While these are just a few example techniques of how the detection component(s) 130 may use the threshold processing to determine when to update the setting(s), in other examples, the detection component(s) 130 may use additional and/or alternative techniques.

The process 100 may then include one or more update components 136 causing the setting(s) associated with the client device and/or the application to be updated. As described herein, in some examples, the update component(s) 136 may use one or more procedures to update the setting(s) associated with the client device and/or the application. For a first example, and as shown by 138, the update component(s) 136 may update the setting(s) by causing one or more additional applications that are being executed by the client device (e.g., the additional application(s) represented by the application data 110) to terminate. As described herein, the update component(s) 136 may use various techniques to cause the additional application(s) to terminate. For instance, in some examples, the update component(s) 136 may cause the client device to provide a request to terminate the additional application(s) and then terminate the additional application(s) based at least on user feedback approving the request. Additionally, or alternatively, in some examples, the update component(s) 136 may automatically terminate an additional application(s) without providing the request to the user.

When multiple additional applications are being executed by the client device, the update component(s) 136 may also determine whether to terminate only a portion of the additional applications and/or all of the additional applications. For instance, in some examples, the update component(s) 136 may determine to terminate the additional application(s) that is not related to the application but is utilizing computing resources also used by the application being provided by the client device. For another instance, in some examples, the update component(s) 136 may determine to terminate the additional application(s) that is utilizing the greatest amount of computing resources, such as the greatest amount of the GPU(s), that is also used by the application being provided by the client device. For example, if a first additional application is utilizing 15% of the GPU(s) while a second additional application is only utilizing 1% of the GPU(s), then the update component(s) 136 may determine to terminate the first additional application without determining to terminate the second additional application, at least initially.

For a second example, and as shown by 140, the update component(s) 136 may update the setting(s) by updating and/or terminating one or more methods associated with the PPU(s). For instance, the PPU(s) may be configured to perform various methods, such as rigid body dynamics, soft body dynamics, collision detection, finite element analysis, fracturing of objects, ragdoll physics, decal rendering, and/or any other method. As such, the update component(s) 136 may cause the PPU(s) to terminate one or more of the methods using one or more techniques, such as based on the amount of resource utilization and/or the frame rate.

For instance, in some examples, if the GPU(s) utilization is within a first range, the PPU(s) utilization is within a first range, and/or the frame drop rate is within a first range, then the update component(s) 136 may cause the PPU(s) to terminate one or more specific methods (e.g., ragdoll physics). Additionally, if the GPU(s) utilization is within a second range, the PPU(s) utilization is within a second range, and/or the frame drop rate is within a second range, where the second ranges are greater than the first ranges, then the update component(s) 136 may cause the PPU(s) to terminate one or more additional methods. Furthermore, if the GPU(s) utilization is within a third range, the PPU(s) utilization is within a third range, and/or the frame drop rate is within a third range, where the third ranges are greater than the second ranges, then the update component(s) 136 may cause the PPU(s) to terminate all renderings. While this is just one example technique of how the update component(s) 136 may cause updating and/or terminating of the methods associated with the PPU(s), in other examples, the update component(s) 136 may use additional and/or alternative techniques.

For a third example, and as shown by 142, the update component(s) 136 may update the setting(s) by updating one or more elements (e.g., parameters) associated with processing of the application, such as processing that is performed within a graphics processing pipeline of the GPU(s). For instance, the elements associated with processing may include, but are not limited to, anti-aliasing, shadow quality, view distance, field-of-view determinations, mapping, and/or other processing elements. As such, the update component(s) 136 may terminate one or more of the elements using one or more techniques, such as based on the amount of resource utilization and/or the frame rate.

For instance, in some examples, if the GPU(s) utilization is within a first range and/or the frame drop rate is within a first range, then the update component(s) 136 may cause termination of a first element. Additionally, if the GPU(s) utilization is within a second range and/or the frame drop rate is within a second range, where the second ranges are greater than the first ranges, then the update component(s) 136 may cause termination of a second element. Furthermore, if the GPU(s) utilization is within a third range and/or the frame drop rate is within a third range, where the third ranges are greater than the second ranges, then the update component(s) 136 may cause termination of a third element. While this is just one example technique of how the update component(s) 136 may cause updating and/or terminating of the processing elements, in other examples, the update component(s) 136 may use additional and/or alternative techniques.

Still, for a fourth example, and as shown by 144, the update component(s) 136 may update the setting(s) by updating one or more clocks associated with the GPU(s), the CPU(s), and/or the PPU(s). As described herein, in some examples, the update component(s) 136 may update the clocks based on one or more factors, such as a power source associated with the client device. For instance, in some examples, if the power source includes an external power source, then the update component(s) 136 may determine not to lower the clock(s) associated with the GPU(s), the CPU(s), and/or the PPU(s). Additionally, if the power source includes one or more internal power sources (e.g., a direct current mode), but a charge of the internal power source(s) satisfies (e.g., is equal to or greater than) a threshold (e.g., 70%, 80%, 90%, etc.), then the update component(s) 136 may again determine not to lower the clock(s) associated with the GPU(s), the CPU(s), and/or the PPU(s). However, if the power source again includes one or more internal power sources, but the charge of the internal power source(s) does not satisfy (e.g., is less than) the threshold, then the update component(s) 136 may determine to lower the clock(s) associated with the GPU(s), the CPU(s), and/or the PPU(s). While this is just one example technique of how the update component(s) 136 may cause updating of the clock(s), in other examples, the update component(s) 136 may use additional and/or alternative techniques.

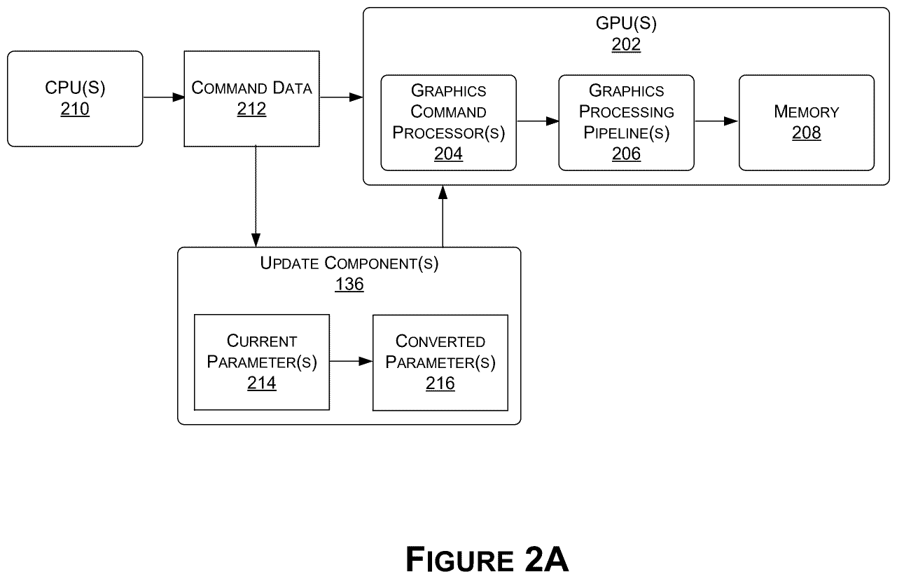

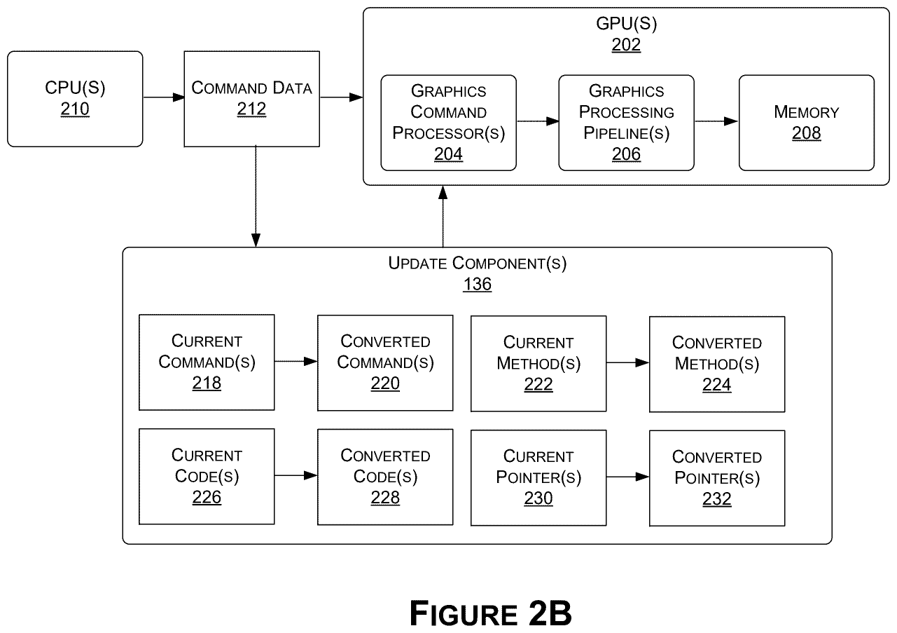

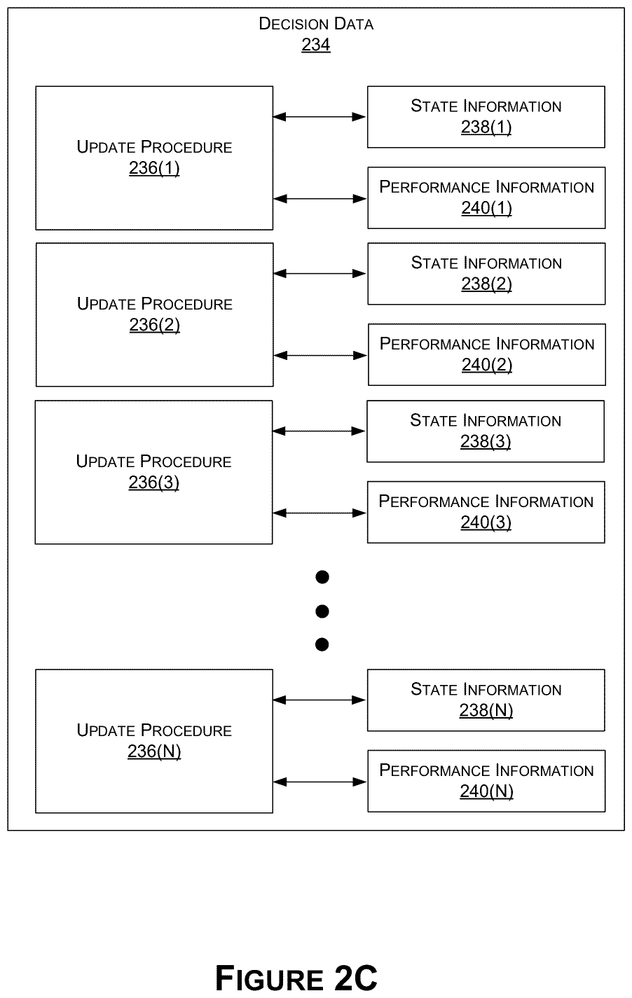

For instance, FIGS. 2A-2B illustrate examples of updating settings associated with an application during a session associated with the application, in accordance with some embodiments of the present disclosure. As shown by the example of FIG. 2A, a GPU(s) 202 may include at least one or more graphics command processors 204, one or more processing pipelines 206, and one or more memories 208 (e.g., a frame buffer, a video memory, a cache, etc.). Additionally, the GPU(s) 202 may be receiving commands from a CPU(s) 210, where the commands may be represented by command data 212. For example, the commands may include graphics commands that cause the GPU(s) 202 to process frames associated with the application using at least the processing pipeline(s) 206. As described herein, the processing pipeline(s) 206 may use various parameters for processing the frames.

As further shown, the update component(s) 136 may receive the command data 212 and use the command data 212 to interpret the commands. In some examples, the update component(s) 136 may continuously receive and/or interpret the commands. However, in other examples, the update component(s) 136 may receive and/or interpret the commands based on events, such as based on a determination to update the setting(s) of the client device and/or the application. In either example, the update component(s) 136 may update one or more current parameters 214 associated with the GPU(s) 202 (e.g., the processing pipeline(s) 206) to include one or more converted parameters 216 (e.g., one or more updated parameters). The update component(s) 136 may then cause the GPU(s) 202 to update the current parameter(s) 214 to the converted parameter(s) 216, which is indicated by the arrows.

For example, if the GPU(s) 202 performs anti-aliasing using a current parameter 214, such as a parameter that indicates a number of samples per pixel to use when performing the anti-aliasing, then a converted parameter 216 may reduce the number of samples per pixel. By reducing the number of samples, the update component(s) 136 may reduce the amount of GPU(s) utilization associated with performing the anti-aliasing. Additional examples of updating parameters using the processes of FIG. 2A may include, but are not limited to, floating point parameter manipulation (e.g., reducing precision of floating point calculations so as to provide negligible difference in position of an object, but save time to avoid complex floating point calculations), parameter nulling and/or zeroing (e.g., force filling parameters with zero or null so that graphics outputs for some unnecessary objects are zero, which gives the net effect of being disabled in order to reduce render time), generic optimization strategy manipulation (updating optimization for triangles, shadows, lighting, and/or the like), dropping commands to avoid processing altogether, and/or any other parameter update.

As shown by the example of FIG. 2B, the update component(s) 136 may perform similar processes as those described with respect to the example of FIG. 2A, but the update component(s) 136 may instead update one or more current commands 218 to be or include one or more updated commands 220 for sending to the GPU(s) 202, update one or more current processing methods 222 to be or include one or more converted processing methods 224 to be performed by the GPU(s) 202, update one or more current codes 226 to be or include one or more converted codes 228 to be applied to the GPU(s) 202, and/or update one or more current pointers 230 to be or include one or more converted pointers 232 for the GPU(s) 202. For an example, if the GPU(s) 202 is configured to perform height mapping when rendering frames, such as to increase a definition of surfaces depicted by the frames, then the update component(s) 136 may update the codes and/or methods of the GPU(s) 202 to just perform normal mapping. In some examples, performing normal mapping may reduce the utilization of the GPU(s) 202 as compared to performing the height mapping.

Referring back to the example of FIG. 1, in some examples, the update component(s) 136 may use one or more techniques to select a procedure for updating the setting(s), such as a decision tree which may be represented by decision data 146. For instance, the decision tree may indicate the various procedures that may be used for updating the setting(s). In some examples, the decision tree may include additional information, such as various state information and/or performance information associated with the procedures. For example, the decision tree may include information indicating to use a first procedure for a first range of state information (e.g., GPU(s) utilization, etc.) and/or a first range of performance information (e.g., frame drop rate, FPS, etc.), use a second procedure for a second range of state information and/or a second range of performance information, use a third procedure for a third range of state information and/or a third range of performance information, and/or so forth. This way, the update component(s) 136 may select the procedure and/or group of procedures that will likely give the best performance based on the actual state of the client device and/or the application.

In some examples, the update component(s) 136 may generate and/or update the decision tree using previous update information associated with previous updates to the setting(s), where the update information may be represented by update data 148. As described herein, the update information may include, but is not limited to, one or more identifiers of one or more applications for which the setting(s) was updated, state information associated with the previous updates, performance information associated with the previous updates, performance information received after the updates occurred (e.g., impacts on the GPU(s) utilization, impacts on the frame rate, impacts on the frame drop rate, etc.), and/or any other information associated with the previous updates to the setting(s). This way, the update component(s) 136 may continue to update the decision tree such that the decision tree indicates the best procedures to use to update the setting(s) in any scenario, such as scenarios that are based on different applications, different ranges for state information, and/or different ranges for performance information.

Additionally, or alternatively, in some examples, one or more additional systems 150, which may be remote from the client device, may generate and/or update one or more decision trees represented by decision data 152. For example, the system(s) 150 may receive the update data 148 representing the update information from one or more client devices when the client device(s) performs one or more of the processes described herein to update settings. The system(s) 150 may then use the received update information to continue updating one or more decision trees associated with one or more client devices and/or one or more applications. Additionally, the system(s) 150 may provide the decision tree(s) to the client device(s), such as based on request, such that the client device(s) is able to use the decision tree(s) when updating the settings. In some examples, by performing such processes, the decision tree(s) may include the most updated information for optimizing settings associated with various applications and/or client devices such that use of the decision tree(s) may provide the best performance when updating settings.

For instance, FIG. 2C illustrates an example of information that may be included as part of a decision tree, in accordance with some embodiments of the present disclosure. As shown, the decision tree, which may be represented by decision data 234 (which may be similar to, and/or include, the decision data 148 and/or the decision data 152), may include information for different updating procedures 236(1)-(N) (also referred to singularly as “procedure 236” or in plural as “procedures 236”). In some examples, the procedures 236 from the example of FIG. 2C may correspond to at least the updating procedures 138-144. The decision tree may also include state information 238(1)-(N) (also referred to singularly or in plural as “state information 238”) associated with the procedures 236, which is indicated by the arrows, and performance information 240(1)-(N) (also referred to singularly or in plural as “performance information 240”) associated with the decision tree, which is also indicated by the arrows.

As such, in the example of FIG. 2C, the client device may use the current state information and/or the current procedure information to determine one or more procedures from the decision tree. For instance, the client device may compare the current state information to the state information 238 and/or the current performance information to the performance information 240 to determine the procedure(s). For example, the client device may determine the procedure(s) for which the current state information most closely matches the state information 238 and/or the current performance information most closely matches the performance information 240. Additionally, in some examples, the client device and/or the system(s) 150 may update the decision tree as new update data is generated with one or more updates to settings associated with the client device. While the decision tree of FIG. 2C shows a pairing-based mechanism, where each decision node (e.g., a set of state information 238 and/or performance information 240) branches to one potential outcome (e.g., an update procedure 236), in some examples, a decision tree can include intricate decision pathways, which may involve multiple levels of branching and a variety of node types to handle different decision criteria and outcomes.

Referring back to the example of FIG. 1, in some examples, the process 100 may then continue to repeat, such as during the session associated with the application. This way, the performance of the application may be optimized on the client device. For example, if after updating the setting(s), the detection component(s) 130 determines that the GPU(s) utilization has decreased (e.g., below the threshold utilization and/or an additional threshold utilization) and/or the frame rate has increased (e.g., to be equal to or greater than a threshold rate), then the update component(s) 136 may update the setting(s) back to the original settings for the client device and/or the application. However, if after updating the setting(s), the detection component(s) 130 determines that the GPU utilization has further increased and/or the frame drop rate has further increased, then the update component(s) 136 may further update one or more additional settings using one or more of the procedures described herein to decrease the GPU(s) utilization and/or decrease the frame drop rate.

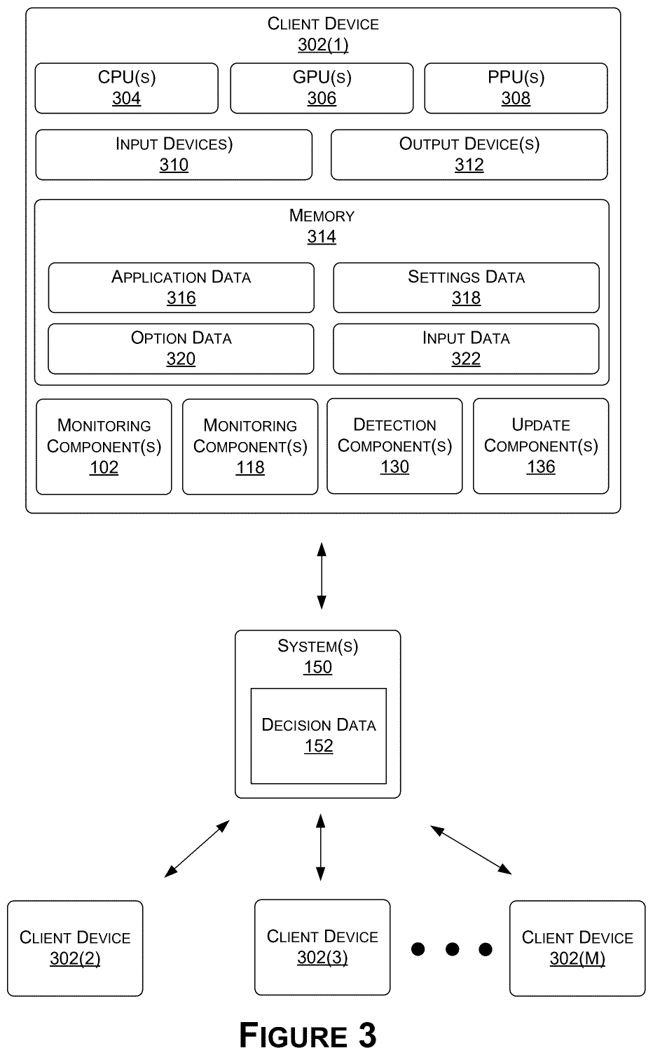

As described herein, in some examples, the process 100 may be performed using one or more computing devices, such as one or more client devices. For instance, FIG. 3 illustrates an example of an architecture for dynamically updating settings associated with an application to optimize performance of the application, in accordance with some embodiments of the present disclosure. As shown, the architecture may include one or more client devise 302(1)-(M) (also referred to singularly as “client device 302” or in plural as “client devices 302”) (which may also represent, and/or include, a client device 904) and the system(s) 150.

In the example of FIG. 3, a client device 302 may include at least one or more CPUs 304 (which may be similar to, and/or include, the CPU(s) 210 and/or a CPU(s) 908), one or more GPUs 306 (which may be similar, and/or include, the GPU(s) 202 and/or a GPU(s) 910), one or more PPUs 308, one or more input devices 310 (which may represent, and/or include, an input device 926), one or more output devices 312, and memory 314. As described herein, the input device(s) 310 may include, but is not limited to, a mouse, a keyboard, a touch-sensitive display, a microphone (e.g., for voice inputs), a joystick, a button, and/or any other type of input device. Additionally, the output device(s) 312 may include, but is not limited to, a display, a speaker, a haptic device, and/or any other type of output device.

As further illustrated by the example of FIG. 3, the client device 302 may include the state-monitoring component(s) 102, the performance-monitoring component(s) 118, the detection component(s) 130, and the update component(s) 136. While the example of FIG. 3 illustrates the state-monitoring component(s) 102, the performance-monitoring component(s) 118, the detection component(s) 130, and the update component(s) 136 as including hardware components, in other examples, the state-monitoring component(s) 102, the performance-monitoring component(s) 118, the detection component(s) 130, and/or the update component(s) 136 may include software components stored in the memory 314. For example, the state-monitoring component(s) 102, the performance-monitoring component(s) 118, the detection component(s) 130, and the update component(s) 136 may be included as part of a companion software application associated with the GPU(s) 306.

The example of FIG. 3 further illustrates the client device 302 as storing application data 316 and settings data 318. As described herein, in some examples, the application data 316 may represent one or more applications that are launched and/or executed by the client device 302. Additionally, the settings data 318 may represent one or more settings, parameters, codes, methods, and/or so forth that may be updated using one or more of the processes described herein, such as one or more settings associated with the CPU(s) 304, the GPU(s) 306, the PPU(s) 308, and/or the application.

As further illustrated by the example of FIG. 3, the system(s) 150 may communicate with the client devices 302, such as to receive update data (e.g., the update data 148) representing the update information associated with updates to settings performed by the client devices 302. The system(s) 150 may then use the update data to update one or more decision trees associated with one or more of the client devices 302 and/or one or more of the applications being executed by the client devices 302. Additionally, the system(s) 150 may then communicate with the client devices 302 to send the decision data 152 representing the decision trees.

The example of FIG. 3 further illustrates that the client device 302 may generate option data 320 and/or input data 322. In some examples, the option data 320 may represent an option for activating one or more of the optimization processes described herein. As described herein, an option may include a visual interface element control, such as a control that is displayed by the client device 302 and selectable by the user, an audible control, such as audio requesting whether the user would like to activate the option, and/or any other type of control. Additionally, in some examples, the input data 322 may represent one or more inputs received by the client device 302, such as by using one or more of the input device(s) 310. For example, if the option data 320 represents an option being provided by the client device 302, then the input data 322 may represent an input selecting the option by the user.

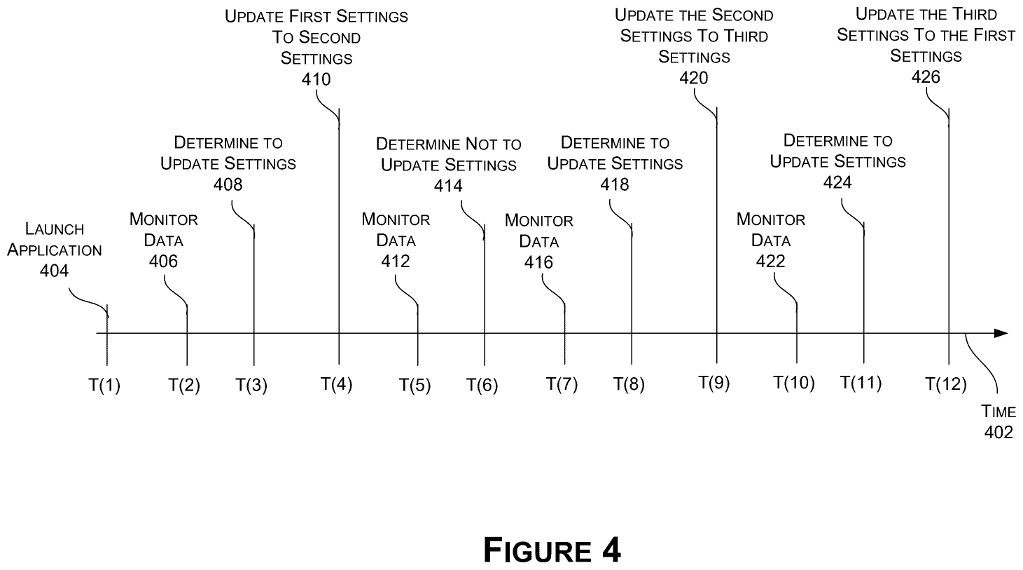

FIG. 4 illustrates an example of updating settings associated with an application over a period of time 402 for which a client device is providing a session associated with the application, in accordance with some embodiments of the present disclosure. As shown, at a first time T(1), the client device may launch a session associated with an application 404 for a user. When the application is launched, the client device and/or the application may be associated with one or more first settings. Next, at a second time T(2) after launching the application, the client device may monitor data 406, such as state data associated with the client device and/or performance data associated with the application. Based at least on the monitoring, and at a third time T(3), the client device may determine to update one or more of the settings 408. For example, the client device may determine that a first GPU(s) utilization satisfies a threshold utilization and/or a first frame drop rate satisfies a threshold rate. As such, and at a fourth time T(4), the client device may update the first settings to include second settings 410, using one or more of the processes described herein.

Next, at a fifth time T(5), the client device may again monitor data 412, such as the state data associated with the client device and/or the performance data associated with the application. Based at least on the monitoring, and at a sixth time T(6), the client device may determine not to update one or more of the settings 414. For example, the client device may determine that a second GPU(s) utilization does not satisfy the threshold utilization and/or a second frame drop rate does not satisfy the threshold rate.

Next, at a seventh time T(7), the client device may again monitor data 416, such as the state data associated with the client device and/or the performance data associated with the application. Based at least on the monitoring, and at an eighth time T(8), the client device may determine to again update one or more of the settings 418. For example, the client device may determine that a third GPU(s) utilization satisfies the threshold utilization and/or a third frame drop rate satisfies the threshold rate. As such, and at a ninth time T(9), the client device may update the second settings to include third settings 420, using one or more of the processes described herein.

Next, at a tenth time T(10), the client device may again monitor data 422, such as the state data associated with the client device and/or the performance data associated with the application. Based at least on the monitoring, and at an eleventh time T(11), the client device may determine to again update one or more of the settings 424. However, at the eleventh time T(11), the client device may determine to update the settings back to the original settings. For example, the client device may determine that a fourth GPU(s) utilization does not satisfy the threshold utilization and/or does not satisfy (e.g., is less than) a second, lower threshold utilization and/or that a fourth frame drop rate does not satisfy the threshold rate and/or is a same as an original frame drop rate. As such, and at a twelfth time T(12), the client device may update the third settings to include the first settings 426, using one or more of the processes described herein.

These processes of monitoring data, determining whether to update settings based at least on monitoring the data, and/or updating the setting may continue during the session associated with the application. As such, in the example of FIG. 4, the client device is able to dynamically update the settings associate with the client device during the session associated with the application in order to optimize the performance of the application (e.g., maintain a frame rate in order to reduce lag).

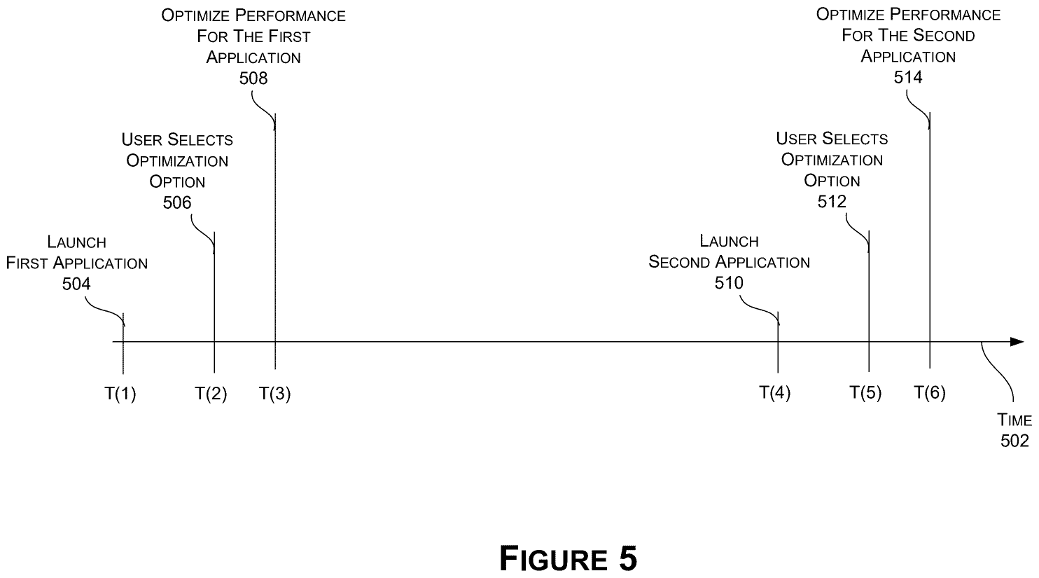

FIG. 5 illustrates an example of optimizing between different applications over a period of time 502, in accordance with some embodiments of the present disclosure. As shown, at a first time T(1), the client device may launch a session associated with a first application 504 for a user. Next, at a second time T(2), the client device may receive an input to optimize performance of the first application 506. As described herein, the input may be any type of input, such as a selection of an interface element (e.g., a graphic, an icon, an image, an option, etc.) provided by the client device, a selection of a physical input (e.g., a button, etc.), a voice input, and/or the like. Additionally, while the example of FIG. 5 illustrates that the input is received after the launching of the first application, in other examples, the input may be received before and/or during the launching of the first application. In any example, at a third time T(3), the client device may perform one or more of the processes described herein to optimize the performance of the first application 508.

Next, at a fourth time T(4), the client device may launch a session associated with a second application 510 for the user. At a fifth time T(5), the client device may receive an input to optimize performance of the second application 512. As described herein, the input may be any type of input, such as a selection of an interface element (e.g., a graphic, an icon, an image, an option, etc.) provided by the client device, a selection of a physical input (e.g., a button, etc.), a voice input, and/or the like. Additionally, while the example of FIG. 5 illustrates that the input is received after the launching of the second application, in other examples, the input may be received before and/or during the launching of the second application. In any example, at a sixth time T(6), the client device may perform one or more of the processes described herein to optimize the performance of the second application 514. In some examples, the client device may terminate the optimization of the first application when the client device begins optimizing the performance of the second application. However, in other examples, the client device may optimize the performances of both applications.

In some examples, rather than the client device receiving the inputs to begin optimizing the performances of the applications, the client device may initially receive one or more inputs indicating that the applications should be optimized and/or indicating a priority for optimizing the applications. For instance, and with regard to the example of FIG. 5, the client device may receive one or more inputs indicating that the second application is to be prioritized over the first application and/or any application. As such, when the second application is launched, the client device may automatically begin to optimize the performance of the second application rather than the performance of the first application.

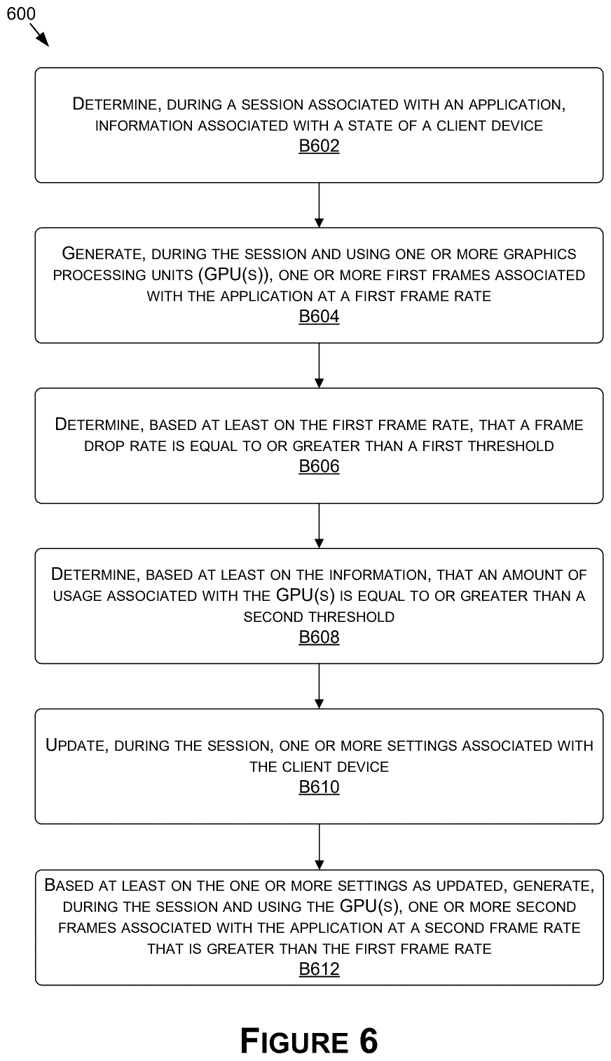

Now referring to FIG. 6-8, each block of methods 600, 700, and 800, described herein, comprises a computing process that may be performed using any combination of hardware, firmware, and/or software. For instance, various functions may be carried out by a processor executing instructions stored in memory. The methods 600, 700, and 800 may also be embodied as computer-usable instructions stored on computer storage media. The methods 600, 700, and 800 may be provided by a standalone application, a service or hosted service (standalone or in combination with another hosted service), or a plug-in to another product, to name a few. In addition, the methods 600, 700, and 800 are described, by way of example, with respect to the system of FIG. 1. However, these methods 600, 700, and 800 may additionally or alternatively be executed by any one system, or any combination of systems, including, but not limited to, those described herein.

FIG. 6 illustrates a flow diagram showing a method 600 for updating settings associated with an application to optimize a performance of the application, in accordance with some embodiments of the present disclosure. The method 600, at block B602, may include determining, during a session associated with an application, information associated with a state of a client device. For instance, the state-monitoring component(s) 102 may receive the state data 104 representing the information associated with the state of the client device (e.g., the client device 302). As described herein, the state data 104 may include, but is not limited to, the utilization data 106, the clock data 108, the application data 110, the power data 112, the machine data 114, the methods data 116, and/or any other data representing information associated with the state of the machine.

The method 600, at block B604, may include generating, during the session and using one or more graphics processing units (GPU(s)), one or more first frames associated with the application at a first frame rate. For instance, the client device may use the GPU(s) (e.g., the GPU(s) 306) to generate the first frame(s) at the first frame rate. As described herein, in some examples, the first frame rate may be based on one or more factors, such as one or more settings associated with the client device. For instance, the first frame rate may be based at least on an amount of usage associated with the GPU(s). For example, the greater the amount of usage associated with the GPU(s), the lower the first frame rate and/or the greater a frame drop rate while the lesser the amount of usage associated with the GPU(s), the greater the first frame rate and/or the lesser the frame drop rate.

The method 600, at bock B606, may include determining that the first frame rate associated with the application is less than a first threshold. For instance, the performance-monitoring component(s) 118 may receive the performance data 120 that includes at least the frame rate data 122 and/or the frame drop data 124. In some examples, the detection component(s) 130 may then determine that the frame drop rate is equal to or greater than the threshold rate. Additionally, or alternatively, in some examples, the detection component(s) 130 may determine that the frame rate is less than another threshold rate.

The method 600, at block B608, may include determining, based at least on the information, that an amount of usage associated with the GPU(s) is equal to or greater than a second threshold. For instance, the detection component(s) 130 may use the information from the state-monitoring component(s) 102 to determine the amount of usage associated with the GPU(s). The detection component(s) 130 may then determine that the amount of usage is equal to or greater than the threshold utilization. In some examples, the detection component(s) 130 may determine additional information, such as one or more causes (e.g., one or more applications, etc.) for why the amount of usage is equal to or greater than the threshold utilization.

The method 600, at block B610, may include updating, during the session, one or more settings associated with the client device. For instance, based at least on the frame drop rate being equal to or greater than the threshold rate (and/or the frame rate being less than the additional threshold rate) and/or the amount of usage associated with the GPU(s) being equal to or greater than the threshold utilization, the detection component(s) 130 may determine to update the setting(s) associated with the application. As such, the update component(s) 136 may use one or more procedures to update the setting(s) using one or more of the processes described herein. Additionally, in some examples, the update component(s) 136 may use additional techniques, such as a decision tree, to determine how to update the setting(s).

The method 600, at block B612, may include, based at least on the one or more settings as updated, generating, during the session and using the GPU(s), one or more second frames associated with the application at a second frame rate that is greater than the first frame rate. For instance, the client device may use the GPU(s) to generate the second frame(s) at the second frame rate. As described herein, in some examples, the second frame rate may be based on one or more factors, such as one or more settings associated with the client device. For instance, the second frame rate may be based at least on an amount of usage associated with the GPU(s). As such, based at least on the updates to the setting(s), the second frame rate may be greater than the first frame rate.

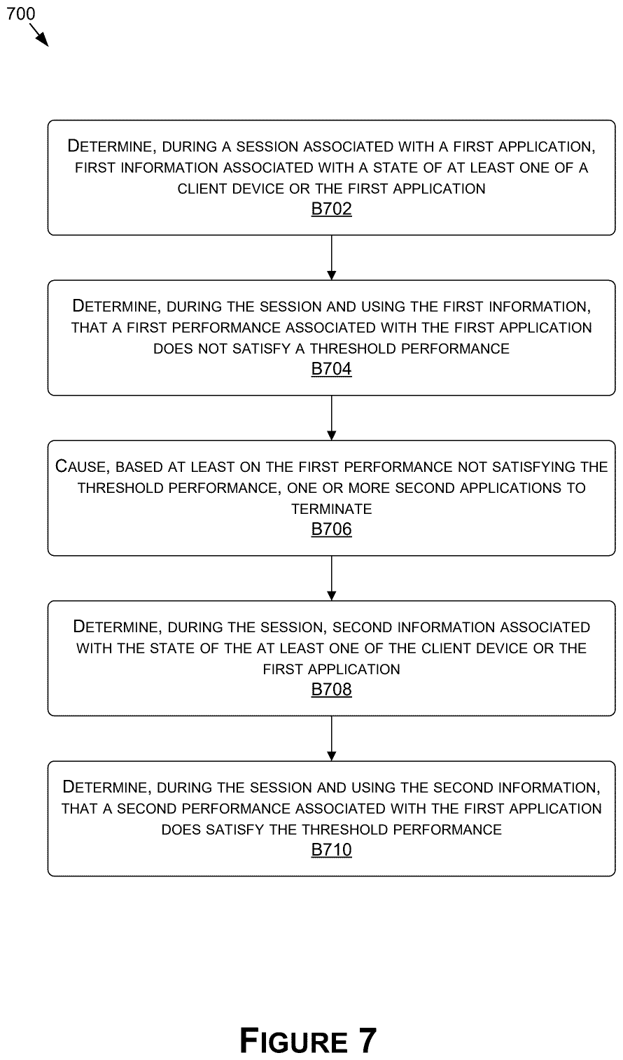

FIG. 7 illustrates a flow diagram showing a method 700 for updating applications executing on a client device in order to optimize a performance of an application, in accordance with some embodiments of the present disclosure. The method 700, at block B702, may include determining, during a session associated with a first application, first information associated with a state of at least one of a client device or the first application. For instance, in some examples, the state-monitoring component(s) 102 may receive the state data 104 representing the first information associated with the state of the client device (e.g., the client device 302). Additionally, or alternatively, in some examples, the performance-monitoring component(s) 118 may receive the performance data 120 representing the first information associated with a first performance of the first application on the client device.

The method 700, at block B704, may include determining, during the session and using the first information, that a first performance associated with the first application does not satisfy a threshold performance. For instance, the detection component(s) 130 may use the first information from the state-monitoring component(s) 102 and/or the performance-monitoring component(s) 118 to determine that the first performance associated with the first application does not satisfy the performance threshold. As described herein, in some examples, the detection component(s) 130 may make the determination based at least on a GPU(s) utilization satisfying a threshold utilization, a frame drop rate satisfying a threshold rate, a frame rate not satisfying a threshold rate, and/or using any other techniques.

The method 700, at block B706, may include causing, based at least on the first performance not satisfying the performance threshold, one or more second applications to terminate. For instance, based at least on the first performance not satisfying the performance threshold, the update component(s) 136 may cause the second application(s) to terminate. As described herein, the update component(s) 136 may cause the second application(s) to terminate since the second application(s) may be using at least a portion of the resources needed by the first application, such as the GPU(s). Additionally, in some examples, the update component(s) 136 may cause the second application(s) to terminate based at least on user input that indicates to terminate the second application(s). Furthermore, in some examples, the detection component(s) 130 may determine the second application(s) based at least on one or more amounts of usage associated with the second application(s).

The method 700, at block B708, may include determining, during the session, second information associated with the state of the at least one of the client device or the first application. For instance, in some examples, the state-monitoring component(s) 102 may receive the state data 104 representing the second information associated with the state of the client device. Additionally, or alternatively, in some examples, the performance-monitoring component(s) 118 may receive the performance data 120 representing the second information associated with a second performance of the first application on the client device.

The method 700, at block B710, may include determining, during the session and using the second information, that a second performance associated with the first application does satisfy the threshold performance. For instance, the detection component(s) 130 may use the second information from the state-monitoring component(s) 102 and/or the performance-monitoring component(s) 118 to determine that the second performance associated with the first application satisfies the performance threshold. As described herein, in some examples, the detection component(s) 130 may make the determination based at least on the GPU(s) utilization not satisfying the threshold utilization, the frame drop rate not satisfying the threshold rate, the frame rate satisfying the threshold rate, and/or using any other techniques.

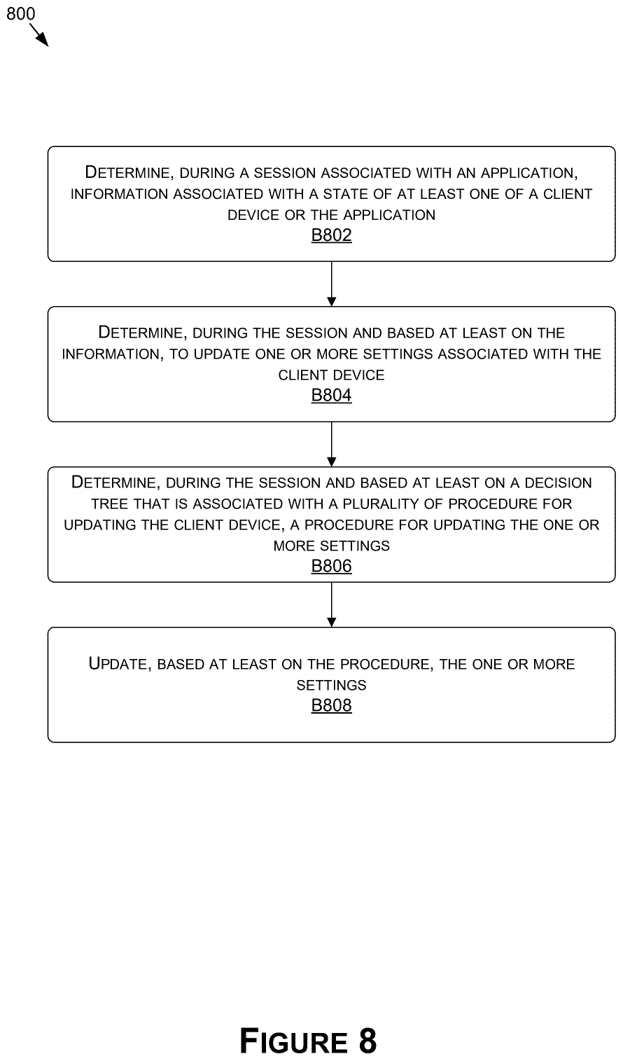

FIG. 8 illustrates a flow diagram showing a method 800 for using a decision tree to optimize a performance of an application, in accordance with some embodiments of the present disclosure. The method 800, at block B802, may include determining, during a session associated with an application, information associated with a state of at least one of a client device or the application. For instance, in some examples, the state-monitoring component(s) 102 may receive the state data 104 representing the information associated with the state of the client device (e.g., the client device 302). Additionally, or alternatively, in some examples, the performance-monitoring component(s) 118 may receive the performance data 120 representing the information associated with the performance of the application on the client device.

The method 800, at block B804, may include determining, during the session and based at least on the information, to update one or more settings associated with the client device. For instance, the detection component(s) 130 may use the information from the state-monitoring component(s) 102 and/or the performance-monitoring component(s) 118 to determine that a performance associated with the application does not satisfy a performance threshold. As described herein, in some examples, the detection component(s) 130 may make the determination based at least on a GPU(s) utilization satisfying a threshold utilization, a frame drop rate satisfying a threshold rate, a frame rate not satisfying a threshold rate, and/or using any other techniques. The detection component(s) 130 may then determine to update the setting(s) based at least on the performance not satisfying the threshold performance.

The method 800, at block B806, may include determining, during the session and based at least on a decision tree that is associated with a plurality of procedures for updating the client device, a procedure for updating the one or more settings. For instance, the update component(s) 136 may use the decision tree to determine the procedure. As described herein, in some examples, the decision tree may indicate the various procedures, where one or more of the procedures are associated with respective state information and/or performance information for which the procedures provide the best results. As such, the update component(s) 136 may use the current information associated with the state of the client device and/or the application to select one of the procedures from the decision tree.

The method 800, at block B808, may include updating, based at least on the procedure, the one or more settings. For instance, the update component(s) 136 may use the procedure to update the setting(s) associated with the client device. As described herein, by updating the setting(s), the performance associated with the application may increase, such as by increasing the frame rate and/or reducing the frame drop rate.

### Example Content Streaming System

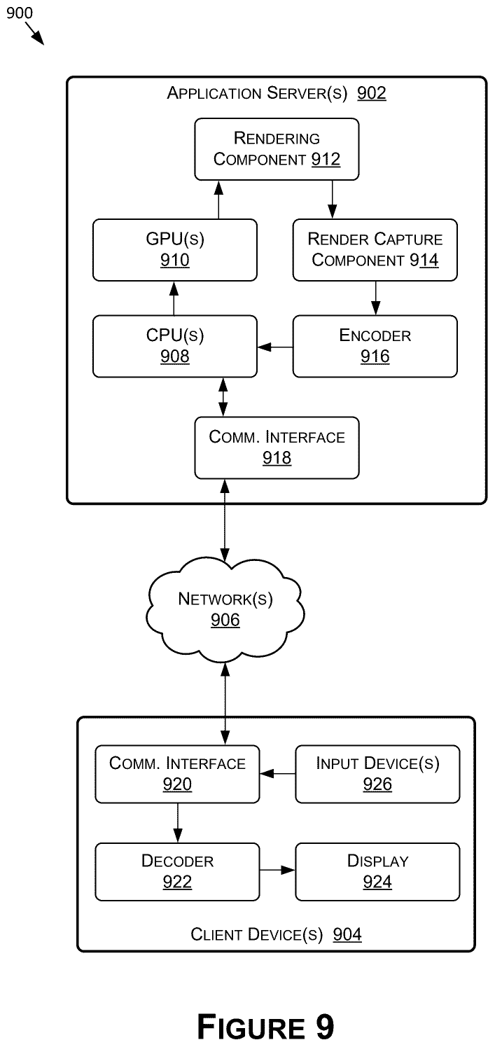

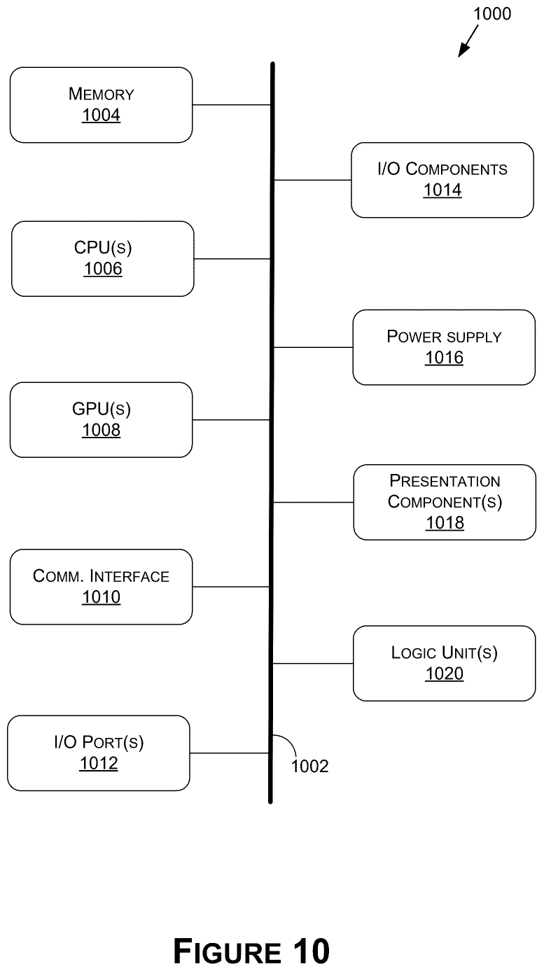

Now referring to FIG. 9, FIG. 9 is an example system diagram for a content streaming system 900, in accordance with some embodiments of the present disclosure. FIG. 9 includes application server(s) 902 (which may include similar components, features, and/or functionality to the example computing device 1000 of FIG. 10), client device(s) 904 (which may include similar components, features, and/or functionality to the example computing device 1000 of FIG. 10), and network(s) 906 (which may be similar to the network(s) described herein). In some embodiments of the present disclosure, the system 900 may be implemented. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 900, for an application session, the client device(s) 904 may only receive input data in response to inputs to the input device(s), transmit the input data to the application server(s) 902, receive encoded display data from the application server(s) 902, and display the display data on the display 924. As such, the more computationally intense computing and processing is offloaded to the application server(s) 902 (e.g., rendering—in particular ray or path tracing—for graphical output of the application session is executed by the GPU(s) of the game server(s) 902). In other words, the application session is streamed to the client device(s) 904 from the application server(s) 902, thereby reducing the requirements of the client device(s) 904 for graphics processing and rendering.

For example, with respect to an instantiation of an application session, a client device 904 may be displaying a frame of the application session on the display 924 based on receiving the display data from the application server(s) 902. The client device 904 may receive an input to one of the input device(s) 926 and generate input data in response. The client device 904 may transmit the input data to the application server(s) 902 via the communication interface 920 and over the network(s) 906 (e.g., the Internet), and the application server(s) 902 may receive the input data via the communication interface 918. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 912 may render the application session (e.g., representative of the result of the input data) and the render capture component 914 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 902. In some embodiments, one or more virtual machines (VMs)—e.g., including one or more virtual components, such as vGPUs, vCPUs, etc.—may be used by the application server(s) 902 to support the application sessions. The encoder 916 may then encode the display data to generate encoded display data and the encoded display data may be transmitted to the client device 904 over the network(s) 906 via the communication interface 918. The client device 904 may receive the encoded display data via the communication interface 920 and the decoder 922 may decode the encoded display data to generate the display data. The client device 904 may then display the display data via the display 924.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

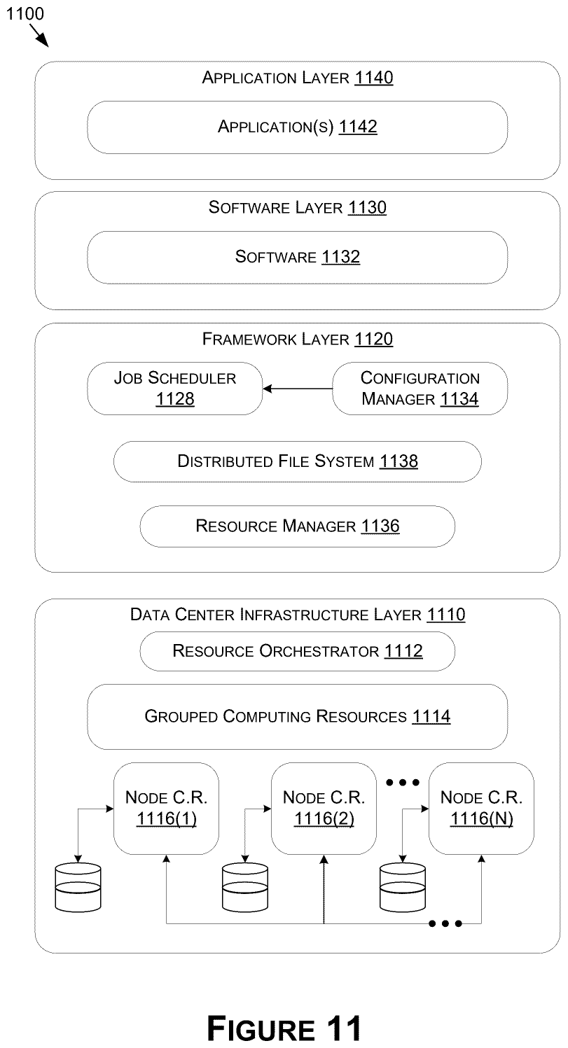

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: A method comprising: determining, during a session associated with an interactive application, information associated with a state of a client device; generating, during the session and using one or more graphics processing units (GPUs), one or more first frames associated with the interactive application at a first frame rate; determining, during the session and based at least on the first frame rate, that a drop rate associated with the interactive application is equal to or greater than a first threshold; determining, during the session and based at least on the information, that an amount of usage associated with the one or more GPUs is equal to or greater than a second threshold; updating, during the session and based at least on the drop rate being equal to or greater than the first threshold and the amount of usage associated with the one or more GPUs being equal to or greater than the second threshold, one or more first settings associated with the client device to include one or more second settings; and based at least on the one or more second settings, generating, during the session and using the one or more GPUs, one or more second frames associated with the interactive application at a second frame rate that is greater than the first frame rate.

B: The method of paragraph A, further comprising: causing the client device to present an option corresponding to updating the one or more first settings associated with the client device; and receiving one or more inputs indicating a selection associated with the option, wherein the updating the one or more first settings associated with the client device is based at least on the selection.

C: The method of either paragraph A or paragraph B, wherein the updating the one or more first settings associated with the client device to include the one or more second settings comprises one or more of: causing termination of one or more second applications that utilize at least a portion of the one or more GPUs; causing one or more first parameters associated with one or more physics processing units (PPUs) to update; causing one or more second parameters associated with the one or more GPUs to update; or causing one or more states of one or more clocks associated with at least one of the one or more GPUs or one or more PPUs to update.

D: The method of any one of paragraphs A-C, further comprising sending, to one or more computing devices, data representative of at least one of: an identifier associated with the interactive application; the first frame rate associated with the interactive application; the drop rate associated with the interactive application; the second frame rate associated with the interactive application; the amount of usage associated with the one or more GPUs; or an indication of the updating of the one or more first settings associated with the client device to the one or more second settings.

E: The method of any one of paragraphs A-D, further comprising: receiving, from one or more computing devices, data corresponding to a decision tree representing one or more procedures for updating settings associated with the client device; and determining, based at least on the decision tree, at least a procedure of the one or more procedures, the procedure associated with updating the one or more first settings from the settings to the one or more second settings, wherein the updating of the one or more first settings associated with the client device to the one or more second settings is further based at least on the procedure.

F: The method of any one of paragraphs A-E, wherein the information associated with the state comprises one or more of: a first usage associated with one or more central processing units (CPUs); a second usage associated with the one or more GPUs; a third usage of one or more physics processing units (PPUs); a first clock associated with the one or more CPUs; a second clock associated with the one or more GPUs; a third clock associated with the one or more PPUs; one or more second applications being executed by the client device; one or more states associated with the interactive application; one or more parameters issued to one or more peripheral component interconnects; or one or more states associated with one or more power sources of the client device.

G: The method of any one of paragraphs A-F, further comprising: determining, during the session associated with the interactive application, second information associated with the state of the client device; determining, during the session and based at least on the second information, that a second amount of usage associated with the one or more GPUs is less than the second threshold; updating, during the session and based at least on the second amount of usage associated with the one or more GPUs being less than the second threshold, the one or more second settings associated with the client device to again include the one or more first settings; and based at least on the one or more first settings, generating, during the session and using the one or more GPUs, one or more third frames associated with the interactive application at a third frame rate that is greater than the first frame rate.

H: A system comprising: one or more processors to: determine, during a session associated with an application, information associated with a state of a client device; determine, during the session and based at least on the information, at least an amount of usage associated with one or more graphics processing units (GPUs) and a first frame rate associated with the one or more GPUs; update, during the session and based at least on the amount of usage and the first frame rate, one or more settings associated with the client device; and based at least on the one or more settings as updated, generate, during the session and using the one or more GPUs, one or more frames associated with the application at a second frame rate that is greater than the first frame rate.

I: The system of paragraph H, wherein the one or more processors are further to: determine, based at least on the first frame rate, that a frame drop rate is equal to or greater than a threshold rate, wherein the one or more settings are updated based at least on the amount of usage and the frame drop rate being equal to or greater than the threshold rate.

J: The system of either paragraph H or paragraph I, wherein the one or more processors are further to: determine that the amount of usage is equal to or greater than a threshold amount of usage, wherein the one or more settings are updated based at least on the amount of usage being equal to or greater than the threshold amount of usage and the first frame rate.

K: The system of any one of paragraphs H-J, wherein the one or more processors are further to: cause a display of an option corresponding to updating the one or more settings associated with the client device; and receive one or more inputs indicating a selection associated with the option, wherein the one or more settings associated with the client device are updated based at least on the selection.

L: The system of any one of paragraphs H-K, wherein the one or more processors are further to: determine, based at least on the information, that the one or more GPUs are being used to execute one or more second applications, wherein the one or more settings associated with the client device are updated by at least terminating the one or more second applications.

M: The system of any one of paragraphs H-L, wherein the one or more processors are further to: determine, based at least on the information, an amount of power associated with one or more internal power sources of the client device; and determining that the amount of power is less than a threshold amount of power, wherein the one or more settings associated with the client device are updated by at least updating one or more clocks associated with the one or more GPUs.

N: The system of any one of paragraphs H-M, wherein the settings associated with the client device are updated by at least one of: causing one or more first parameters associated with one or more physics processing units to update; or causing one or more second parameters associated with the one or more GPUs to update.

O: The system of any one of paragraphs H-N, wherein the one or more processors are further to: obtain a decision tree representing one or more procedures for updating settings associated with the client device; and determining, based at least on the decision tree, at least a procedure of the one or more procedures, the procedure associated with updating the one or more settings from the settings, wherein the updating the one or more settings is further based at least on the procedure.

P: The system of paragraph O, wherein the one or more processors are further to: send, to one or more computing devices, a request for the decision tree; and receive, from the one or more computing devices and based at least on the request, data representative of the decision tree.

Q: The system of any one of paragraphs H-P, wherein the one or more settings are updated from one or more first settings to one or more second settings, and wherein the one or more processors are further to: determine, during the session associated with the application, second information associated with the state of the client device; determine, during the session and based at least on the second information, at least a second amount of usage associated with the one or more GPUs and the second frame rate associated with the one or more GPUs; update, during the session and based at least on the second amount of usage and the second frame rate, the one or more second settings associated with the client device to include one or more first settings; and based at least on the one or more first settings, generate, during the session and using the one or more GPUs, one or more second frames associated with the application at a third frame rate that is greater than the first frame rate.

R: The system of any one of paragraphs H-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to: determine, during a session associated with an application being provided by a client device, a procedure from one or more procedures of a decision tree based at least on at least one of an amount of usage associated with one or more graphics processing units (GPUs) or a frame drop rate associated with the one or more GPUs; and updating, during the session and based at least on the procedure, one or more settings associated with the client device.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
determining, during a session associated with an interactive application, information associated with a state of a client device;
generating, during the session and using one or more graphics processing units (GPUs), one or more first frames associated with the interactive application at a first frame rate;
determining, during the session and based at least on the first frame rate, that a drop rate associated with the interactive application is equal to or greater than a first threshold;
determining, during the session and based at least on the information, that an amount of usage associated with the one or more GPUs is equal to or greater than a second threshold;
updating, during the session and based at least on the drop rate being equal to or greater than the first threshold and the amount of usage associated with the one or more GPUs being equal to or greater than the second threshold, one or more first settings associated with the client device to include one or more second settings; and
based at least on the one or more second settings, generating, during the session and using the one or more GPUs, one or more second frames associated with the interactive application at a second frame rate that is greater than the first frame rate.

2. The method of claim 1, further comprising:
causing the client device to present an option corresponding to updating the one or more first settings associated with the client device; and
receiving one or more inputs indicating a selection associated with the option,
wherein the updating the one or more first settings associated with the client device is based at least on the selection.

3. The method of claim 1, wherein the updating the one or more first settings associated with the client device to include the one or more second settings comprises one or more of:
causing termination of one or more second applications that utilize at least a portion of the one or more GPUs;
causing one or more first parameters associated with one or more physics processing units (PPUs) to update;
causing one or more second parameters associated with the one or more GPUs to update; or
causing one or more states of one or more clocks associated with at least one of the one or more GPUs or one or more PPUs to update.

4. The method of claim 1, further comprising sending, to one or more computing devices, data representative of at least one of:
an identifier associated with the interactive application;
the first frame rate associated with the interactive application;
the drop rate associated with the interactive application;
the second frame rate associated with the interactive application;
the amount of usage associated with the one or more GPUs; or
an indication of the updating of the one or more first settings associated with the client device to the one or more second settings.

5. The method of claim 1, further comprising:
receiving, from one or more computing devices, data corresponding to a decision tree representing one or more procedures for updating settings associated with the client device; and
determining, based at least on the decision tree, at least a procedure of the one or more procedures, the procedure associated with updating the one or more first settings from the settings to the one or more second settings,
wherein the updating of the one or more first settings associated with the client device to the one or more second settings is further based at least on the procedure.

6. The method of claim 1, wherein the information associated with the state comprises one or more of:
a first usage associated with one or more central processing units (CPUs);
a second usage associated with the one or more GPUs;
a third usage of one or more physics processing units (PPUs);
a first clock associated with the one or more CPUs;
a second clock associated with the one or more GPUs;
a third clock associated with the one or more PPUs;
one or more second applications being executed by the client device;
one or more states associated with the interactive application;
one or more parameters issued to one or more peripheral component interconnects; or
one or more states associated with one or more power sources of the client device.

7. The method of claim 1, further comprising:
determining, during the session associated with the interactive application, second information associated with the state of the client device;
determining, during the session and based at least on the second information, that a second amount of usage associated with the one or more GPUs is less than the second threshold;
updating, during the session and based at least on the second amount of usage associated with the one or more GPUs being less than the second threshold, the one or more second settings associated with the client device to again include the one or more first settings; and
based at least on the one or more first settings, generating, during the session and using the one or more GPUs, one or more third frames associated with the interactive application at a third frame rate that is greater than the first frame rate.

8. A system comprising:
one or more processors to:
determine, during a session associated with an application, information associated with a state of a client device;
determine, during the session and based at least on the information, at least an amount of usage associated with one or more graphics processing units (GPUs) and a first frame rate associated with the one or more GPUs;
update, during the session and based at least on the amount of usage and the first frame rate, one or more settings associated with the client device; and
based at least on the one or more settings as updated, generate, during the session and using the one or more GPUs, one or more frames associated with the application at a second frame rate that is greater than the first frame rate.

9. The system of claim 8, wherein the one or more processors are further to:
determine, based at least on the first frame rate, that a frame drop rate is equal to or greater than a threshold rate,
wherein the one or more settings are updated based at least on the amount of usage and the frame drop rate being equal to or greater than the threshold rate.

10. The system of claim 8, wherein the one or more processors are further to:
determine that the amount of usage is equal to or greater than a threshold amount of usage,
wherein the one or more settings are updated based at least on the amount of usage being equal to or greater than the threshold amount of usage and the first frame rate.

11. The system of claim 8, wherein the one or more processors are further to:
cause a display of an option corresponding to updating the one or more settings associated with the client device; and
receive one or more inputs indicating a selection associated with the option,
wherein the one or more settings associated with the client device are updated based at least on the selection.

12. The system of claim 8, wherein the one or more processors are further to:
determine, based at least on the information, that the one or more GPUs are being used to execute one or more second applications,
wherein the one or more settings associated with the client device are updated by at least terminating the one or more second applications.

13. The system of claim 8, wherein the one or more processors are further to:
determine, based at least on the information, an amount of power associated with one or more internal power sources of the client device; and
determining that the amount of power is less than a threshold amount of power,
wherein the one or more settings associated with the client device are updated by at least updating one or more clocks associated with the one or more GPUs.

14. The system of claim 8, wherein the settings associated with the client device are updated by at least one of:
causing one or more first parameters associated with one or more physics processing units to update; or
causing one or more second parameters associated with the one or more GPUs to update.

15. The system of claim 8, wherein the one or more processors are further to:
obtain a decision tree representing one or more procedures for updating settings associated with the client device; and
determining, based at least on the decision tree, at least a procedure of the one or more procedures, the procedure associated with updating the one or more settings from the settings,
wherein the updating the one or more settings is further based at least on the procedure.

16. The system of claim 15, wherein the one or more processors are further to:
send, to one or more computing devices, a request for the decision tree; and
receive, from the one or more computing devices and based at least on the request, data representative of the decision tree.

17. The system of claim 8, wherein the one or more settings are updated from one or more first settings to one or more second settings, and wherein the one or more processors are further to:
determine, during the session associated with the application, second information associated with the state of the client device;
determine, during the session and based at least on the second information, at least a second amount of usage associated with the one or more GPUs and the second frame rate associated with the one or more GPUs;
update, during the session and based at least on the second amount of usage and the second frame rate, the one or more second settings associated with the client device to include one or more first settings; and
based at least on the one or more first settings, generate, during the session and using the one or more GPUs, one or more second frames associated with the application at a third frame rate that is greater than the first frame rate.

18. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to:
determine, during a session associated with an application being provided by a client device, a procedure from one or more procedures of a decision tree based at least on at least one of an amount of usage associated with one or more graphics processing units (GPUs) or a frame drop rate associated with the one or more GPUs; and
updating, during the session and based at least on the procedure, one or more settings associated with the client device.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
